(19) United States
(12) Patent Application Publication
(10) Pub. No.: US 2004/0066343 A1
(43) Pub. Date: Apr. 8, 2004

(54) Clip for mounting a novelty item

(76) Inventors: Ralph Thomas Puett III, Corona, CA (US); Ralph Thomas Puett IV, Corona, CA (US)

Correspondence Address: SNELL & WILMER LLP, 1920 MAIN STREET, SUITE 1200, IRVINE, CA, 92614-7230, US

(21) Appl. No.: 10/255,816

(22) Filed: Sep. 26, 2002

(51) Int. Cl. H01Q 1/00; H01Q 1/12; H01Q 1/32

(52) U.S. Cl. 343/720; 343/878; 343/711

(57) ABSTRACT

The present invention relates generally to novelty items, and more particularly to a clip used to mount a novelty item such as a pennant, figurine, or advertising shape on to a post such as an automobile antenna or a writing utensil. A preferred embodiment of the present invention is a novel device to securely locate a novelty item such as a pennant or figure on a post such as an automobile antenna using a clip that secures the item rigidly to the antenna at a selected location, and provides a conical mount that cooperates with a corresponding conical aperture on the mounted item to provide a fitted attachment anywhere along the length of the antenna.

### FIELD OF THE INVENTION

The present invention relates generally to novelty items, and more particularly to a clip used to mount a novelty item such as a pennant, figurine, or advertising shape on to a post such as an automobile antenna or a writing utensil.

### BACKGROUND OF THE INVENTION

It has become very popular to display various items on one's automobile antenna. Further, the proliferation of items that one can mount on an automobile antenna grows every day. Numerous items can be mounted on an antenna from pennants that show support for one's favorite team, to souvenirs that reflect a visit to a favorite vacation destination, to gas station and fast food figures and shapes. However, it is often difficult to mount the item on the antenna in a manner that will reduce the risk that the item will become dislodged or disconnected during actually driving conditions. When driving at a high rate of speed, the item may be subjected to large dynamic forces caused by movement of air over the vehicle causing the item to become separated from the antenna. To date, it has been customary to locate the item at the very top of the antenna since the art lacked a means to locate the item at an intermediate location along the length of the antenna.

### SUMMARY OF THE INVENTION

The present invention relates generally to novelty items, and more particularly to a clip used to mount a novelty item such as a pennant, figurine, or advertising shape on to a post such as an automobile antenna or a writing utensil. A preferred embodiment of the present invention is a novel device to securely locate a novelty item such as a pennant or figure on a post such as an automobile antenna using a clip that secures the item rigidly to the antenna at a selected location, and provides a conical mount that cooperates with a corresponding conical aperture on the mounted item to provide a fitted attachment anywhere along the length of the antenna.

### BRIEF DESCRIPTION OF THE DRAWINGS

The exact nature of this invention, as well as its objects and advantages, will become readily apparent upon reference to the following detailed description when considered in conjunction with the accompanying drawings, in which like reference numerals designate like parts throughout the figures thereof, and wherein:

FIG. 1 is a partial exploded front view of a preferred embodiment of the invention mounted on an antenna.

FIG. 2a is a side exploded view of a preferred embodiment of the conical frustum.

FIG. 2b is bottom view of a preferred embodiment of the conical frustum.

FIG. 2c is a top view of a preferred embodiment of the conical frustum.

FIG. 2d is a side view of a preferred embodiment of one half of the conical frustum.

FIG. 3 is a front view of a preferred embodiment of the invention mounted on an antenna.

FIG. 4 is an alternative embodiment of the invention as mounted to an antenna.

FIG. 5 is an alternative embodiment of the invention mounted to a writing utensil.

FIG. 6 is top view of a preferred embodiment of the display item shown in FIG. 3.

### DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein specifically to provide a clip for mounting a novelty item.

FIG. 1 illustrates a preferred embodiment of the present invention 10. Two halves of a clip 22, 24 cooperate to preferably form a conical frustum 20 that when snapped in place secures to an antenna 100 and supports a novelty item 30 such as a racing tire, a pennant, or a football helmet. The conical frustum 20 is a preferred embodiment of a wedge clip 20. In general, the wedge clip 20 is insertable into a tapered aperture 35 of the novelty item 30 to support the item 30 on the antenna 100.

A channel 25 through the middle of the frustum accommodates an antenna 100 and is formed by a semi-circular groove longitudinally disposed in each half 22, 24 of the clip. When the clip 20 is closed on an antenna 100, the two semi-circular grooves are juxtaposed to form an annular channel 25 sized to receive the antenna 100 about its circumference with a compressive force. The channel 25 is open at both ends of the clip 20 to allow the clip 20 to be located along the antenna length as opposed to be limited to only the top of the antenna. The compressive force is sufficient to clamp the clip 20 to the antenna 100 to reliably secure the clip 20.

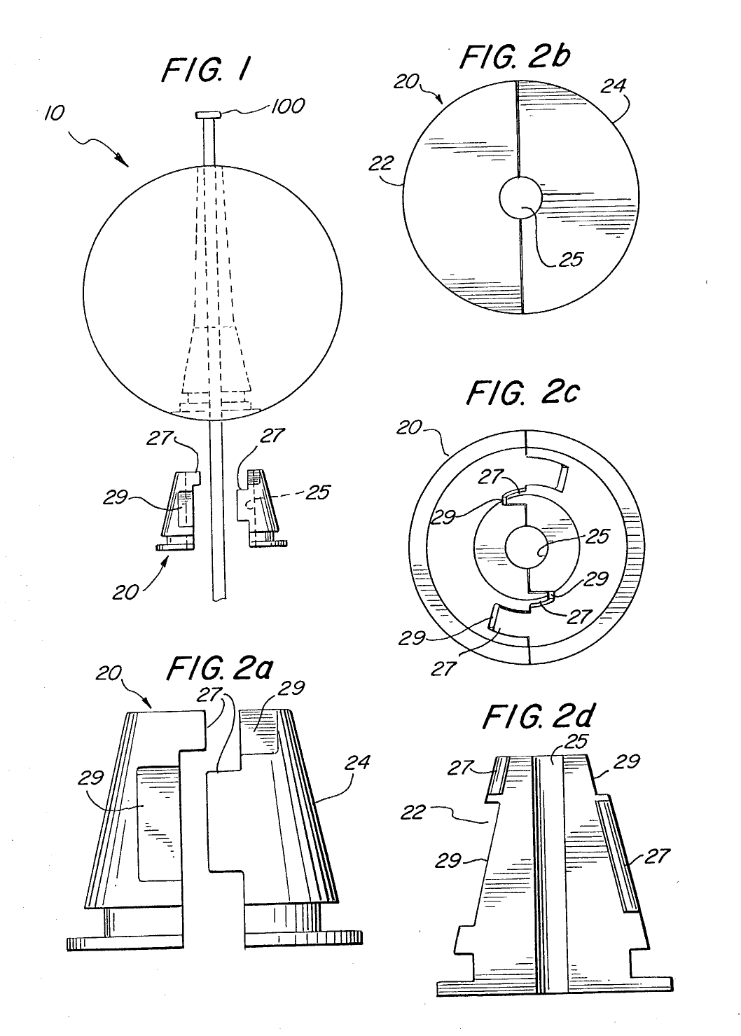

Referring now to FIGS. 2a-2d, to create the compressive force, two resilient tabs 27 depend from opposite edges of each half 22, 24 of the clip. When brought in initial contact with each other, there is a slight interference as the tabs 27 contact a corresponding portion of the complimentary edge of the other half. Further pressure as the halves 22, 24 are pushed toward each other overcomes the interference as the tabs 27 slide over the complimentary edge and become seated in a corresponding slot 29 sized to receive the tab 27. The slots 29 are preferably sized such that the engagement of the tab 27 with the slot 29 places the two components in compression. There is preferably at least one set of tabs and slots on each side of each half of the clip, creating a more stable compressive force that is less likely to twist or pry loose. Each half of the conical section snaps into alignment with each its corresponding mating other half as shown in FIGS. 2a-2d, and the compressive force generated by the engagement of the tabs 27 with the slots 29 provides a frictional resistance that holds the clip 20 and the novelty item 30 at its designated position on the antenna.

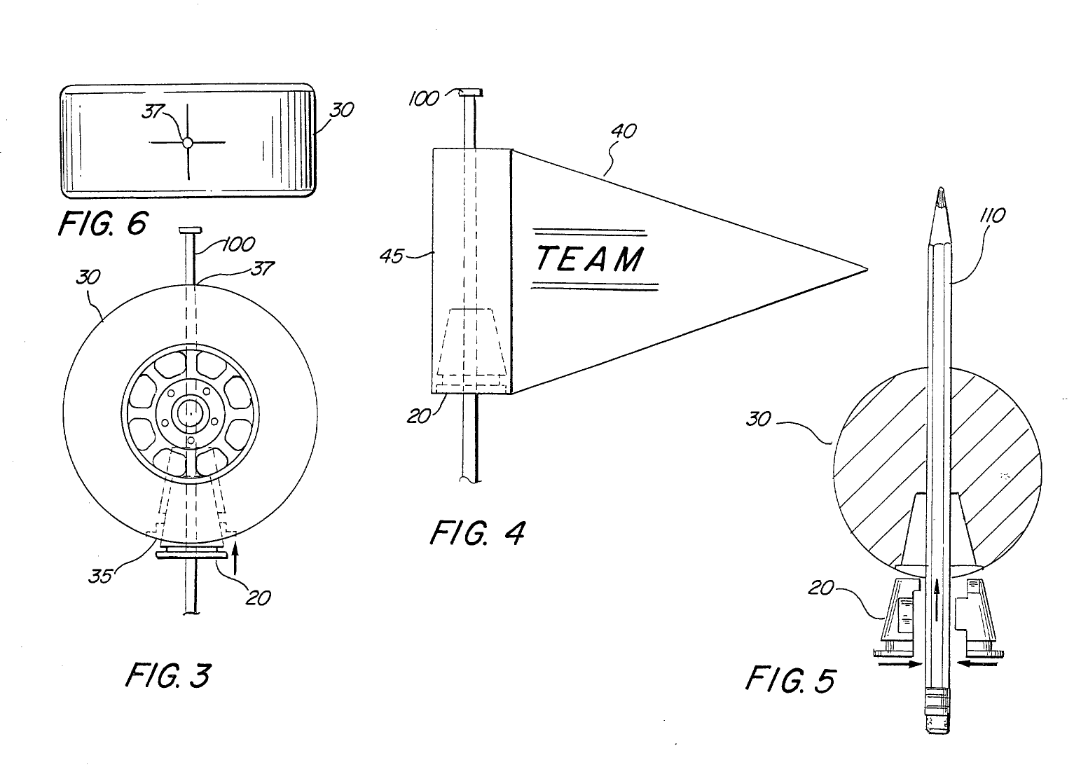

FIG. 3 illustrates the clip 20 supporting the novelty item 30 on an antenna 100. As can be seen in the figure, the novelty item 30 depicted includes a conical aperture 35. The aperture 35 corresponds with the shape of the clip 30, which is preferably conical. The novelty item 30 rests on and is secured to the clip 20 after being placed over the antenna 100 and moved downward until mated with the clip 20. To this end, the novelty item will ordinarily have a passage through the item 30 to the top of the item to allow the antenna 100 to pass through an aperture 37 on the top surface of the novelty item 30, and an opening along its upper surface to permit the antenna to pass through. A preferred embodiment of the aperture 37 is shown in FIG. 6. As shown, the aperture 37 is preferably a small hole at the center of a cross-shaped perforation in the material of the display item 30. The perforation allows the aperture 37 to expand to fit over the top of an antenna and then contract to the antenna's narrower diameter. With this configuration, the novelty item 30 can be passed down along the length of the antenna 100 to the location of the clip 20, and be set at a desired position on the antenna 100.

It is to be understood that the novelty item can take various forms and still be displayed by the clip 20 of the present invention. A few of the many possibilities for adorning an automobile are: a miniature of a football helmet, a soccer ball, basketball, or race car wheel, the head of a cartoon character, or a soft drink can. An exemplary alternative embodiment of a display item pennant 40 using the clip 20 is shown in FIG. 4. The pennant 40 can be secured to a display item mount 45. The mount 45 is then secured to an antenna 100 using the clip 20 and tapered aperture 35 arrangement as described above.

Alternatively, the clip 20 and tapered aperture 35 arrangement can support a novelty item 35 on a variety of cylindrical posts such as writing utensils. The channel 25 of the clip 20 can be varied in sized to accommodate various cylindrical posts. For example, referring now to FIG. 5, the present invention 10 can be configured to mount on a pencil 110.

Thus, a clip for novelty items is described above that allows a user to mount a novelty item onto, inter alia, an automobile antenna or other cylindrical post such as a writing utensil anywhere along the length of the post. Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. An antenna mountable novelty item comprising:
a display component having a top surface and a bottom surface where the top surface has an aperture for an antenna and where the bottom surface has a conical aperture; and, a conical frustum having two separable halves, each half having a portion of an antenna channel to be formed when the halves are joined;
where the conical frustum fits into the conical aperture for mounting the novelty item to an antenna.

2. The antenna mountable novelty item of claim 1 where each half of the conical frustum comprises a resilient tab.

3. The antenna mountable novelty item of claim 1 where the halves are in compression when joined.

4. The antenna mountable novelty item of claim 1 where the display item is a pennant with a post.

5. The antenna mountable novelty item of claim 2 where each half of the conical frustum comprises a secondary resilient tab.

6. A display item mounted to an automobile antenna, where the item comprises:
a display component having a top surface and a bottom surface where the top surface has an aperture for the antenna and where the bottom surface has a conical aperture; and,
a conical frustum having two separable halves, each half having a portion of an antenna channel to be formed when the halves are joined, the halves joining in compression around the circumference of the antenna and where the conical frustum fits into the conical aperture and mounts the item to the antenna.

7. The automobile antenna item of claim 6 where the halves of the conical frustum each comprise a primary and secondary resilient tab.

8. The automobile antenna mountable item of claim 6 where the halves of the conical frustum join in compression and friction to fix the item to a position on the antenna.

9. The automobile antenna mountable item of claim 6 where display item is a pennant with a post.

10. The automobile antenna mountable item of claim 6 where the display item is a depiction of a racing tire.

11. The automobile antenna mountable item of claim 6 where the top surface aperture is perforated to allow expansion of the aperture when moved along a cross-section of the antenna have a varying circumference.

12. A novelty item clip comprising:
a display item having a top surface and a bottom surface where the top surface has a top surface aperture and the bottom surface has a tapered aperture; and,
a wedge clip inserted into the tapered aperture of the display item and held by a force fit, the wedge clip having two halves, each half having a portion of a channel, and where each half is joinable to the other half to form the channel.

13. The novelty item clip of claim 12 where wedge clip is mountable to a writing utensil.

14. The novelty item clip of claim 12 where the wedge clip is mountable to an antenna.

15. The novelty item clip of claim 12 where the wedge clip halves each have a resilient tab.
